(19) United States
(12) Patent Application Publication
(10) Pub. No.: US 2006/0228611 A1
(43) Pub. Date: Oct. 12, 2006

(54) Fuel cell power generating system with deoxidation tank

(75) Inventors: Mitsuaki Nakata, Tokyo (JP); Hideo Maeda, Tokyo (JP); Hidenori Koseki, Tokyo (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: Mitsubishi Denki Kabushiki Kaisha, Tokyo (JP)

(21) Appl. No.: 11/289,566

(22) Filed: Nov. 30, 2005

(30) Foreign Application Priority Data
Apr. 12, 2005 (JP) 2005-114758

(51) Int. Cl. H01M 8/04

(52) U.S. Cl. 429/34; 429/26; 429/25

(57) ABSTRACT

A fuel cell power generating system includes a tank containing a deoxidizer. The deoxidizer generates an inactive gas used in the fuel cell power generating system. Additionally, the system includes a booster that fills the tank with compressed gas. The compressed gas is deoxidized by the deoxidizer in the tank to generate the inactive gas.

### CROSS-REFERENCE TO RELATED APPLICATION

This application claims priority, under 35 U.S.C.§119 (a)-(d), to Japanese patent application no. 2005-114758, filed in the Japanese Patent Office on Apr. 12, 2005.

### BACKGROUND OF THE INVENTION

1. Field of the Invention

This present invention relates generally to a fuel cell power generating system, and more particularly, to a system that generates nitrogen gas that replaces flammable gas in a subsystem including an electrode of anode of the fuel cell and/or a fuel reforming unit, when the system is stopped or that prevents air aspiration into the subsystem caused by temperature drop.

2. Discussion of the Background

A known fuel cell power generating system has an inactive gas cylinder in order to replace flammable gas in the subsystem when the system is stopped or in order to prevent air aspiration into the subsystem caused by temperature drop. when replacing the flammable gas, the inactive gas pushes the flammable gas out of the system.

The addition of the inactive gas cylinder increases ancillary facilities and increases the burden of management of the gas in the fuel cell power generating system. Therefore, a fuel cell power generating system that generates inactive gas in the system itself is being studied. For example, Japanese patent application publication no. H06-203865 discloses a system that, at first, deoxidizes oxygen-bearing gas by oxygen removal equipment, including a deoxidizer, while the gas is circulating. Then the system stores the generated inactive gas (nitrogen gas) within a storage tank to use the gas for replacement of the flammable gas in the subsystem.

In the above fuel cell power generating system that generates nitrogen gas, the deoxidizer requires a sufficient deoxidization reaction rate relative to the flow rate of the oxygen-bearing gas circulating in the oxygen removal equipment. Additionally, the efficiency of the deoxidizer declines through repeated use of the deoxidizer in redox reactions. As a result, this system requires a high quality, and large amount of, deoxidizer.

Therefore, there is a previously unaddressed need to address at least the aforementioned deficiencies and inadequacies.

### SUMMARY OF THE INVENTION

According to one embodiment of the invention, a fuel cell power generating system includes a tank containing a deoxidizer. The deoxidizer generates an inactive gas used in the fuel cell power generating system. Additionally, the system includes a booster that fills the tank with compressed gas. The compressed gas is deoxidized by the deoxidizer in the tank to generate the inactive gas.

According to another embodiment, the system includes a deoxidization gas line. This line supplies deoxidizing gas to the tank in order to deoxidize the deoxidizer within the tank.

### BRIEF DESCRIPTION OF THE DRAWINGS

The invention is best understood from the following detailed description when read in conjunction with the accompanying drawings, wherein:

FIG. 1 is a block diagram showing a structure of a fuel cell power generating system corresponding to a first exemplary embodiment of the present invention.

FIG. 2 is a block diagram showing a structure of a fuel cell power generating system corresponding to a second exemplary embodiment of the present invention.

FIG. 3 is a block diagram showing a structure of a fuel cell power generating system corresponding to a third exemplary embodiment of the present invention.

### DETAILED DESCRIPTION OF THE EMBODIMENTS

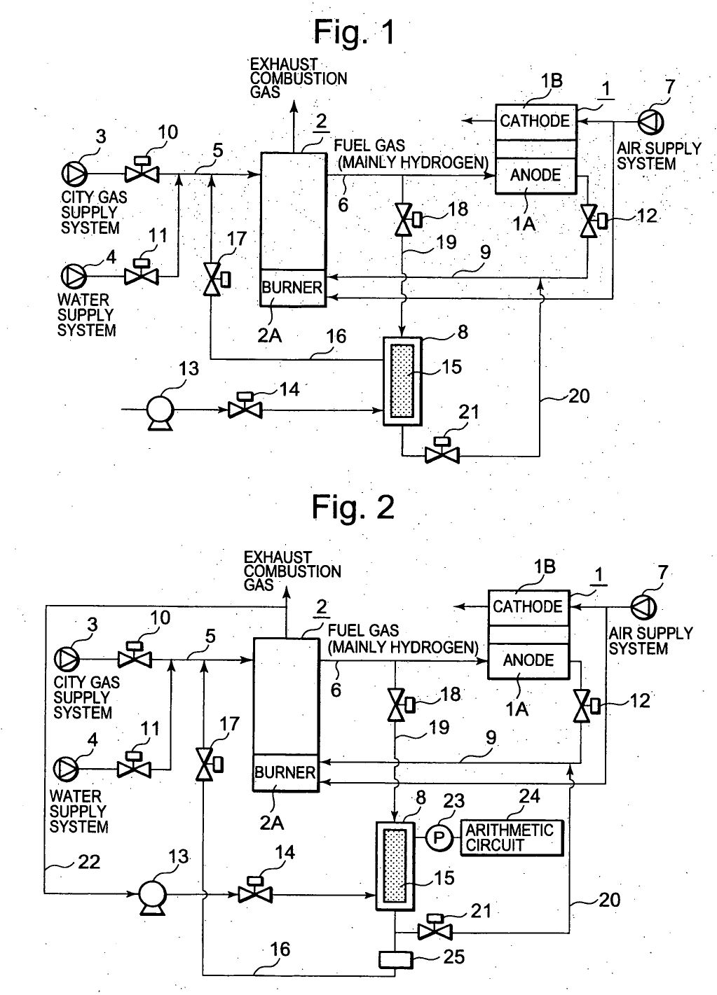

FIG. 1 is a block diagram of the exemplary structure of a fuel cell power generating system of a first embodiment of the present invention. This type of system may be used during the day at locations such as stores and companies that require large amounts of daytime electric power consumption. If the fuel cell power generating system is turned on and off everyday, it is generally preferable to generate the inactive gas used while the system is off at a low cost.

As shown in FIG. 1, the fuel cell power generating system includes a solid polymer fuel cell 1 as a fuel cell for generating electricity by using hydrogen and fuel reforming unit 2 for converting city gas to fuel gas mainly including hydrogen by a steam reforming reaction. The system of FIG. 1 also includes a city gas supply system 3 for supplying the city gas as raw material to the fuel reforming unit 2, a water supply system 4 for supplying water to the fuel reforming unit 2, a raw material supply line 5 for mixing the city gas and the water and directing their flow into the fuel reforming unit 2, a fuel gas supply line 6 for directing the fuel gas (consisting mainly of hydrogen and generated by the fuel reforming unit 2) into the solid polymer fuel cell 1, and an air supply system 7 for supplying air to the solid polymer fuel cell 1. The system of FIG. 1 also has a tank 8 (first tank) for storing inactive gas to be supplied to the solid polymer fuel cell 1 and the fuel reforming unit 2, for example, to replace the flammable gas in the subsystem when the system is turned off or to prevent air aspiration into the subsystem caused by temperature drop from occurring.

In this example, city gas is supplied to the fuel reforming unit 2 as a raw material mixed with water. The fuel reforming unit 2 generates the fuel gas, which is mainly hydrogen, by a steam reforming reaction. Then the fuel reforming unit 2 supplies the fuel gas to an anode 1A of the solid polymer fuel cell 1. In addition, the air supply system 7 supplies air to the cathode 1B of the solid polymer fuel cell. The solid polymer fuel cell 1 generates electricity by reacting hydrogen and oxygen in the air under the following reaction formulas:
H₂→2H⁺+2e⁻ (1)
½×O₂+2H⁺+2e⁻H₂O (2).

The reaction (1) occurs at the anode 1A, and electrons derived from the reaction (1) are used as electricity external to the system of FIG. 1. The used electrons reach the cathode 1B and the reaction (2) occurs between oxygen and the hydrogen ions (H+) which have traveled through the inside of the solid polymer fuel cell 1.

Generation of hydrogen, by the steam reforming reaction, in the fuel reforming unit 2 occurs at about 700 degrees Celsius, which normally requires some reaction heat. The fuel reforming unit 2 includes burner 2A which raises the temperature of the fuel reforming unit 2 to about 700 degrees Celsius and supplies the reaction heat. The burner 2A burns the anode exhaust gas which includes hydrogen. The anode exhaust gas supply line 9 supplies the anode exhaust gas to the burner 2A.

The exemplary system of FIG. 1 includes a cutoff valve 10 between the city gas supply system 3 and the raw material supply line 5. Also, there is a cutoff valve 11 between the water supply system 4 and the raw material supply line 5 to stop the supply of city gas and water to the fuel reforming unit 2 when the system is turned off. Cutoff valve 12 in the anode exhaust gas supply line 9 stops the flow of the anode exhaust gas when the system is turned off. If, by mistake, air enters the fuel reforming unit 2 when the system is turned off, it causes performance degradation by oxidization of the catalyst. Therefore, nitrogen gas is encapsulated in the subsystem when the system is turned off. The area from cutoff valves 10 and 11 located upstream of the raw material supply line 5 to cutoff valve 12 located downstream of the anode 1A is called a subsystem. The compressor 13 increases the pressure of air which is used as the oxygen-bearing gas in this example. Compressor 13 is used as a booster. The air compressed by the compressor 13 is stored in the tank 8 through the cutoff valve 14. The capacity of the tank 8 is configured to be several liters per generated power output of about 10 k watt.

The tank 8 is filled with deoxidizer 15. The deoxidizer is any suitable material that removes oxygen by its being oxidized. For example, the deoxidizer 15 may be metal powder or pig of such as copper, iron, and nickel, or molding made of metal powder and ceramics. Tank 8 is located adjacent the fuel reforming unit 2 so that heat is conducted from the fuel reforming unit 2 to the tank 8. The tank 8 is also located at the appropriate position so that the temperature of the deoxidizer 15 in the tank 8 is kept, for example, at 100 degrees Celsius while the fuel reforming unit 2 and the solid polymer fuel cell 1 are operated. The position of the tank may be decided according to either or both of the fuel reforming unit 2 and the solid polymer fuel cell 1. The operative temperature of the deoxidizer 15 is set by taking the performance of the catalytic substance required for redox into account. Gas that has been generated by removing oxygen, by the deoxidizer 15, from air in the tank 8 and mainly comprising nitrogen is hereinafter referred to as nitrogen gas generated by deoxidization (GBD-nitrogen gas). The GBD-nitrogen gas is an inactive gas.

As described above, it is possible to avoid using an additional heat source and to improve energy efficiency of the fuel cell power generating system by using the heat from the fuel cell power generating system to meet the temperature condition under which the oxidation reaction and reductive reaction by the deoxidizer 15 in the tank 8 occur efficiently.

GBD-nitrogen gas supply line 16 (an inactive gas line) connects the tank 8 and the raw material supply line 5 via a cutoff valve 17 (first cut off valve). When the fuel cell power generating system is stopped, the raw material supply line 5, the fuel reforming unit 2, the fuel gas supply line 6, the solid polymer fuel cell 1, and the anode exhaust gas supply line 9 are filled by the GBD-nitrogen gas by opening the cutoff valve 17 and thereby allowing the GBD-nitrogen gas to go through the GBD-nitrogen gas supply line 16.

In addition, in order to use a part of the fuel gas for deoxidizing (i.e., removing oxygen from) the deoxidizer 15, the fuel cell power generating system of FIG. 1 includes a deoxidizing gas supply line 19 as a deoxidizing gas line, diverged from the fuel gas supply line 6 and connected to the tank 8 via a cutoff valve 18. The fuel cell power generating system further includes a deoxidizing gas discharge line 20 for returning the gas exiting the tank 8 to a point along the anode exhaust gas supply line 9. There is a cutoff valve 21 on the deoxidizing gas discharge line 20.

Next, the operation of the embodiment is explained. The following operation is also an example of the operation and it should not be used to restrict the scope of the invention.

In order to deoxidize the deoxidizer 15, while the fuel reforming unit 2 is being operated, the cutoff valve 18 and the cutoff valve 21 are kept open, and the cutoff valve 14 and the cutoff valve 17 are kept closed, for only a prescribed period of time. As an example, this prescribed period of time may range from several tens of minutes to several hours. During this prescribed period, a portion of the fuel gas, which is mainly hydrogen, is supplied to the tank 8. The deoxidizer 15 is deoxidized by the fuel gas, and the function of the deoxidizer 15 is thereby restored. Un-reacted hydrogen exited the tank 8 is burned at the burner 2A. From the point of view of improvement of the efficiency of the fuel cell power generating system, it is desirable to install a flow control means (not illustrated) such as an orifice, on the deoxidizing gas supply line 19 or on the deoxidizing gas discharge line 20, for setting an appropriate flow volume that is neither excessive nor deficient.

After deoxidization of the deoxidizer 15, the cutoff valve 18 and the cutoff valve 21 are closed, the cutoff valve 14 is opened, and compressed air is supplied to the tank 8 by the compressor 13. After supplying air to the tank 8 up to the upper pressure limit of the tank 8 (for example, a pressure of 10 atmospheres), compressor 13 is turned off, and the cutoff valve 14 is closed. The air supplied to the tank 8 is converted to the GBD-nitrogen gas (the inactive gas) by being deoxidized by the deoxidizer 15 and stored in the tank 8.

Because oxygen is removed from the air by the deoxidization, the pressure of the gas in the tank 8 becomes lower than the upper pressure limit which was achieved when the air was supplied to the tank 8. Assuming an oxygen concentration of the air is a (here, for example 20%), the pressure falls to (1−a) times by removing most of the oxygen. When the pressure falls to a prescribed level, compressed air is supplied to the tank 8 by the compressor 13 by opening the cutoff valve 14 again. By repeating the process of turning off the compressor 13 and closing the cutoff valve 14 after supplying the air to the tank 8 up to the upper pressure limit of the tank 8, it is possible to store nitrogen gas, having almost reached the upper pressure limit in the tank 8. After waiting for completion of the deoxidization by the deoxidizer 15 in the tank 8, tank 8 is filled with GBD-nitrogen gas.

At the first air filling, air equal to the volume of the tank 8 under the upper pressure limit of the tank 8 is supplied. On the other hand, at the second air filling or later, air having the same volume as that of the removed oxygen is supplied to the tank 8. Therefore, the volume of the air supplied to the tank 8 becomes smaller and smaller. Assuming that the deoxidizer 15 removes oxygen at a rate proportional to the probability that oxygen molecules touch the deoxidizer 15 (i.e. the oxygen concentration), it is possible to say that as for the oxygen concentration in the tank 8, the logarithm of the oxygen concentration decreases in proportion to time. Therefore, the time it takes for the oxygen concentration to become β (for example 0.1) times the oxygen concentration just after filling is constant and does not depend on the oxygen concentration. Assuming the time it takes for the oxygen concentration to become β is T (for example, 2 minutes), the time needed to fill the tank with air is zero, air is supplied at the end of each time period T for a total of n times (i.e. n is the number of time periods T), an oxygen concentration just after filling is C(n), and an oxygen concentration right before the next filling is D(n), the following relationships exist.

Since oxygen is removed by the deoxidizer 15, the following formula is derived:
D(n)=β×C(n) (3).

Since extra air is filled instead of the oxygen that was removed by the deoxidizer 15, the following formula is derived:
C(n+1)=D(n)+(C(n)−D(n))×α (4).

Based on formulas (3) and (4) and the fact that C(1)=α just after the first filling, the following formulas are derived:
C(n)=(β+(1−β)×α)ⁿ⁻¹×α (5)
D(n)=(β+(1−β)×α)ⁿ⁻¹×α×β (6).

When the difference between the upper pressure limit and the pressure of the gas in the tank after oxygen removal is under γ (for example, 1%), the repeat count N required to fill the tank 8 with that gas is given by the minimum n that can make the C(n) obtained by the formula (5) lower than γ. When β=0.1, N is 3, and when β=0.01, N is also 3. Because T for β=0.01 becomes twice as much as T for β=0.1, the time required to finish repetition of air filling for β=0.1 is shorter than that for β=0.01. Although the abovementioned process does not occur exactly as shown in the above equations because it takes from several seconds to several tens of seconds to fill the tank 8 with air and, while the tank 8 is being filled with air, the air is being deoxidized by the deoxidizer 15, nearly the same results are observed in practice.

GBD-nitrogen gas, generated and stored in the tank 8 is used as an inactive gas for replacing gas within the subsystem of the fuel cell power generating system when power generation is stopped, or is used for supplementing inactive gas for preventing aspiration caused by negative pressure when the fuel cell power generating system is turned off. The replacement of gas within the subsystem by the inactive gas is performed by stopping the supply of the raw material by closing cutoff valve 10 and cutoff valve 11, and by directing the GBD-nitrogen gas into raw material supply line 5 through GBD-nitrogen gas supply line 16 by opening the cutoff valve 17. It is possible to regulate the volume of flowing GBD-nitrogen gas by installing a flow control mechanism (not illustrated) such as an orifice. In addition, the replacement of gas in the subsystem by the inactive gas can be performed not only when the fuel cell power generating system is turned off, but also when it is turned on.

Even after the subsystem is filled with the inactive gas, the GBD-gas is made to circulate in the subsystem for the following reason. When the fuel cell power generating system is turned off, the burning process by the burner 2A is also turned off. This makes the temperature of the fuel cell power generating system drop, and this temperature drop reduces the gas pressure within the subsystem. Therefore the GBD-gas is made to circulate in the subsystem to prevent aspiration caused by negative pressure within the subsystem.

After the temperature drops to an appropriate level, the cutoff valve 12 and the cutoff valve 17 are closed. On the other hand, it is also possible to make the subsystem an enclosed space by closing the cutoff valve 12 and the cutoff valve 17 before the temperature drops to that level, and to provide the subsystem with the GBD-nitrogen gas, with pressure higher than the atmospheric pressure, via a pressure controlling mechanism. This enables the subsystem to keep an appropriate pressure, higher than the atmospheric pressure, even after the pressure drop caused by the temperature drop.

In this exemplary embodiment, the deoxidizer 15 is placed in the tank 8, and pressurized oxygen-bearing gas stored in the tank 8 is deoxidized. Hereinafter, the method of this embodiment is called “the static system method.” Other systems, where oxygen-bearing gas is first deoxidized by circulating the oxygen-bearing gas through a deoxidizer and then the deoxidized gas is stored in the tank, use “the circulating system method.”

Under the static system method, it is possible to increase dramatically the contact time between the deoxidizer 15, contributing to the deoxidization, and the oxygen-bearing gas. Even a deoxidizer 15 having a poor deoxidization reaction rate may perform enough deoxidization. Therefore, it is not necessary to use a high quality deoxidizer 15, and it is possible to reduce the amount of the deoxidizer 15.

The amount of deoxidizer 15 required by the circulating system method and the static system method is explained as follows. First, the basics of deoxidization reaction are explained. The deoxidizer 15 is made up of spatially dispersed materials that can absorb oxygen. In exemplary embodiments of the present invention, copper series catalyst may be used, and the deoxidization reaction may be performed at 100 degrees Celsius. The volume of 150 grams of deoxidizer 15 is about 0.15 liters. If air contacts the 150 grams of deoxidizer 15 for one and a half minutes, the oxygen concentration reduces to 0.1%. If air contacts the same amount of deoxidizer having the same efficiency for the same time, the amount of decrease in oxygen concentration is not different between the static system method and circulating system method.

When deoxidization is performed under the circulating system method with oxygen removal equipment including about 150 grams of deoxidizer having a volume of 0.15 liters and if the current speed of the air is 0.1 liters/min, it takes 50 minutes for 5 liters of air to pass through the oxygen removal equipment. In this case, the oxygen concentration of the air going out of the oxygen removal equipment becomes 0.1% because the air can stay in the oxygen removal equipment for an average of one and half minutes. If it is required to perform the deoxidization in a shorter time, it is necessary to increase the volume of the oxygen removal equipment and the volume of the deoxidizer 15. For example, when 1500 grams of deoxidizer, having weight and volume ten times greater than the previous example, is used for the oxygen removal equipment, and if the current speed of the air is 1 liter/min, the oxygen concentration of the air going out of the oxygen removal equipment becomes 0.1%.

Next, as for the static system method, deoxidization is explained for a case where 150 grams of deoxidizer occupying about 0.15 liters is arranged in the tank 8 having 0.5 liters and air with a pressure of 10 atmospheres is filled in the tank 8 at 100 degrees Celsius. In this case, it is equivalent to filling the tank 8 with 5 liters of air at 100 degrees Celsius, and the time ratio of the gas in the tank 8 contacting the deoxidizer 15 becomes 0.3 (0.15/0.5=3). Therefore, the average time for the air to keep contacting the deoxidizer 15 five minutes after filling the tank 8 with air becomes one and a half minutes, and the oxygen concentration in the tank 8 becomes 0.1%. The oxygen concentration decreases more and more as time passes. On the other hand, where deoxidization is performed for a longer time, less deoxidizer 15 may be used. For example, 15 grams of oxidizer is enough under the static system method to make the oxygen concentration 0.1% fifty minutes after filling the tank 8.

As stated above, since the deoxidizer contacts compressed air under the static system method, it is possible for the static system method to increase the amount of gas contacting the deoxidizer, when compared to the circulating system method. It is also possible to decrease the amount of deoxidizer required to generate the same amount of deoxidized gas during the same time, when compared to the circulating system method. Since, under the static system method, deoxidization is performed while air is stored in the tank 8, it is also possible to spend a longer time performing deoxidization. Thus, it is possible to use less deoxidizer while spending a longer time performing deoxidization.

In addition, under the static system method, it is possible to use deoxidizers having a low deoxidization reaction rate, and it is possible to use cheaper porous metallic grains rather than a highly dispersed metal-supported catalyst having a high quality.

In this embodiment, the example of a fuel cell power generating system having the fuel reforming unit 2 that converts raw material (for example, hydro carbon) such as city gas to fuel gas including mainly hydrogen was explained. However, this invention is also applicable to a fuel cell power generating system having a hydrogen supply system as hydrogen supply means for supplying hydrogen to the fuel cell.

Additionally, the line and the cutoff valve used for replacing gas within the subsystem by the inactive gas may also be used as a line and a cutoff valve for circulating the fuel gas for deoxidizing the deoxidizer 15. For example, it is possible to replace gas in the subsystem with the inactive gas by eliminating the GBD-nitrogen gas supply line 16 and cutoff valve 17 by opening cutoff valve 18 and closing cutoff valve 21. It is also possible to supply the inactive gas to the subsystem without eliminating the GBD-nitrogen gas supply line 16 and cutoff valve 17 by opening both cutoff valve 18 and cutoff valve 17 and closing cutoff valve 21.

Although, this embodiment employs a structure which sends the gas that exited tank 8 during deoxidization of deoxidizer 15 to burner 2A, it is also possible to send the gas to an entrance side of the anode 1A of the fuel cell. Instead of keeping the cutoff valve 18 open during the deoxidization of the deoxidizer 15, it is also possible to close the cutoff valve 18 periodically and perform the deoxidization with hydrogen remaining in the tank 8. This makes it possible to use hydrogen for the deoxidization reaction efficiently. Also, performing the last part of the deoxidization with the hydrogen remaining in the tank 8 can decrease the concentration of the hydrogen in the tank 8. This makes it possible to reduce the possibility that oxygen and hydrogen react rapidly when the oxygen-bearing gas contributing to the deoxidization is supplied. Since it is possible to prevent the increase of the concentration of hydrogen caused by diffusion of the fuel gas, it is more efficient to perform the deoxidization process by closing the cutoff valve 18. The effect obtained by supplying the gas for deoxidization intermittently is common to other systems using gas other than hydrogen.

Although this embodiment employs a procedure for generating the GBD-nitrogen gas while the fuel cell power generating system is generating power, any timing is fine for generating the GBD-nitrogen gas if the deoxidizer 15 is in a deoxidized condition and has a function for removing oxygen. For example the GBD-nitrogen gas may be generated after the power generation stops, may be generated when the fuel cell power generating system is turned on, or may be generated at different times.

The above explanation is also applicable to other embodiments.

FIG. 2 is a block diagram to show a structure of a fuel cell power generating system of a second exemplary embodiment of the present invention. In this embodiment, exhaust combustion gas, discharged from the fuel reforming unit 2 and having lower oxygen concentration compared with air, is used as the oxygen bearing gas for generating GBD-nitrogen gas.

Only the different points from the FIG. 1 in the first embodiment are explained. An exhaust combustion gas supply line 22, as a fuel gas line for sending a part of exhaust gas out of the fuel reforming unit 2 to compressor 13, is added. In addition, a pressure gauge 23 as a pressure measurement means for measuring pressure of stored gas in the tank 8, an arithmetic circuit 24 (an operation circuit) for calculating reaction rate of the deoxidizer 15 based on input pressure measured by the pressure gauge 23, and a drain tank 25 located on the GBD-nitrogen gas supply line 16 for gathering condensed water existing in the tank 8 are added.

Next, the operation of this embodiment is explained. The deoxidization of the deoxidizer 15 is performed in a manner similar to the first embodiment. After deoxidization of the deoxidizer 15, the cutoff valve 18 and the cutoff valve 21 are closed, and the cutoff valve 14 is opened. A part of the exhaust gas, coming out of the fuel reforming unit 2 and carried through the exhaust combustion gas supply line 22, is compressed and supplied to the tank 8 by the compressor 13. The deoxidization process is performed in a manner similar to the first embodiment, while the arithmetic circuit 24 is calculating the reaction rate of the deoxidizer 15 according to data of pressure change measured by the pressure gauge 23 by using data related with temperature measured in advance. The calculated reaction rate of the deoxidizer 15 is used as information for deciding if the deoxidizer 15 is performing adequately.

When performing the deoxidization process by supplying the oxygen-bearing gas to the tank 8, the pressure of the stored gas decreases, as the deoxidization process progresses. In other words, the decrease of pressure per unit time is proportional to the reaction rate of the deoxidizer 15. Repeating the redox reaction makes performance of the deoxidizer 15 deteriorate. When the reaction rate of deoxidization by the deoxidizer 15 decreases, the rate of decrease of the gas pressure in the tank 8 decreases. Therefore, it is possible to determine the changes needed by the catalyst resulting from deterioration of its performance, by calculating the reaction rate of the deoxidizer 15. The reaction rate of the deoxidizer is calculated by inputting the decrease in pressure, measured by the pressure gauge 23, to the arithmetic circuit 24. It is possible to amend the calculation by the arithmetic circuit 24 by measuring some information related to pressure condition such as temperature change of the stored gas, so as to make a more accurate determination of the reaction rate.

Replacement of the gas in the subsystem by the inactive gas is performed, as in the first embodiment, by sending the GBD-nitrogen gas to the raw material supply line 5 through the GBD-nitrogen gas supply line 16 by opening the cutoff valve 17 when the fuel cell power generating system is stopped. Since there is a drain tank 25 on the GBD-nitrogen gas supply line 16, it is possible to discharge condensed water generated in the tank 8 outside of the tank 8.

Since this embodiment also employs the deoxidization reaction under the static system method, it is possible to increase the contacting time between the deoxidizer, contributing to the deoxidization process, and the oxygen-bearing gas dramatically compared to the circulating system method. Therefore it is possible to use deoxidizers having a poor deoxidization reaction rate, and it is possible to reduce the amount of the deoxidizer necessary for the deoxidization reaction.

Since the exhaust combustion gas discharged from the fuel reforming unit 2 has a lower oxygen concentration compared to air, it is possible to shorten the time for the deoxidization process in the tank 8 and/or reduce the amount of deoxidizer 15.

In addition, having the arithmetic circuit 24 for calculating the reaction rate makes it possible to determine more accurately whether there is a need for changing the deoxidizer 15.

Although, this embodiment employs a structure which uses combustion gas, it is possible to obtain a similar effect by using gas generated in the fuel cell power generating system and having an oxygen concentration lower than that of air. For example, it is possible to use exhaust gas from the cathode of the fuel cell. Air can be mixed with combustion gas or/and exhaust gas from the cathode of the fuel cell. Also, it is desirable to perform steam separation before raising pressure by the compressor when oxygen-bearing gas including water is supplied.

Although, this embodiment has a drain tank 25 on the GBD-nitrogen gas supply line 16, it is also appropriate to place the drain tank 25 in other locations, such as the deoxidizing gas discharge line 20. The drain tank 25 may be placed on any line into which gas from the tank 8 flows.

The explanation above is also applicable to other embodiments.

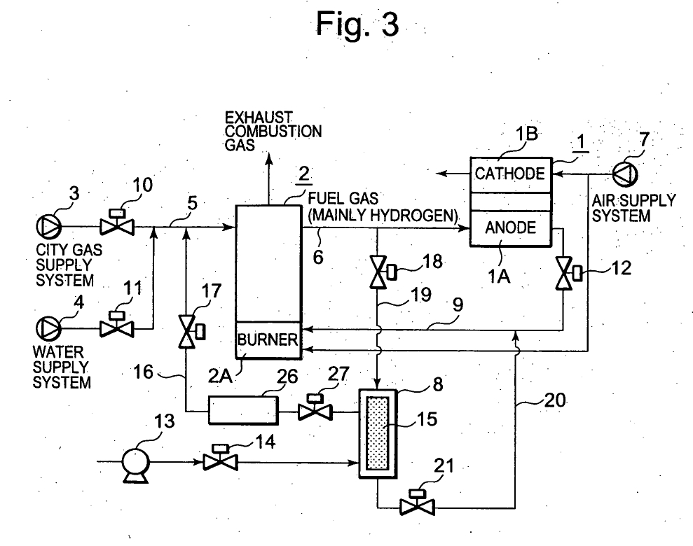

FIG. 3 is a block diagram of a fuel cell power generating system of a third exemplary embodiment of the present invention. In this third embodiment, a normal temperature tank 26 as a second tank and a cutoff valve 27 as a second cutoff valve are placed on the GBD-nitrogen gas supply line 16 between the cutoff valve 17 and the tank 8. The normal temperature tank 26 is placed at a location where the temperature inside and outside of the normal temperature tank 26 become room temperature, whereas the tank 8 is placed at a specified location where the temperature of the deoxidizer 15 in the tank 8 is kept at 100 degrees Celsius while the fuel reforming unit 2 and the solid polymer fuel cell 1 are being operated.

An example of the operation of the third embodiment is explained as follows. The deoxidization process of and by the deoxidizer 15 filled in the tank 8 is performed in a process similar to that of the first embodiment. In order to deoxidize the deoxidizer 15, only for a predetermined time, the cutoff valve 18 and the cutoff valve 21 are opened, and the cutoff valve 14, cutoff valve 17, and the cutoff valve 27 are closed, while the fuel reforming unit 2 is being operated. During the period in this state, a part of the fuel gas consisting mainly of hydrogen is supplied to the tank 8. The deoxidizer 15 is deoxidized by the fuel gas and regains its efficiency as a deoxidizer.

After the deoxidization of the deoxidizer 15, the cutoff valve 18 and the cutoff valve 21 are closed, the cutoff valve 14 is opened, and compressed air is supplied to the tank 8 by the compressor 13. After supplying air to the tank 8 up to the upper pressure limit (for example, 10 atmospheres) the compressor 13 is turned off and the cutoff valve 14 is closed. At this point, the air supplied to the tank 8 is deoxidized by the deoxidizer 15, and GBD-nitrogen gas (including mainly nitrogen) as an inactive gas is left and stored in the tank 8.

After the deoxidization process has progressed as desired, the pressure of the tank 8 and that of the normal temperature tank 26 are made uniform by opening cutoff valve 27 and thereby the GBD-nitrogen gas is distributed to both tanks (8 and 26). Then, the cutoff valve 27 is closed, the cutoff valve 14 is opened, and the compressor 13 supplies compressed air to the tank 8 again. It is possible to store GBD-nitrogen gas having a pressure almost equal to the upper pressure limit in both the tank 8 and the normal temperature tank 26, by repeating the process of supplying air to the tank 8 up to the upper pressure limit, turning off the compressor 13, closing the cutoff valve 14, and making the pressure of the tank 8 and that of the normal temperature tank 26 uniform by opening the cutoff valve 27 after the deoxidization process.

The higher the temperature of the gas in the tank 8, the smaller the capacity of stored GBD-nitrogen gas per tank under the same pressure for storing. In this embodiment, even if the temperature of the tank 8 used for the deoxidization reaction is higher than room temperature, it is possible to increase the amount of GBD-nitrogen gas per tank capacity that is the sum of the capacity of the tank 8 and the normal temperature tank 26. Also, the higher the capacity ratio of the normal temperature tank 26 to the tank 8, the better the effect becomes.

It is possible to use the GBD-nitrogen gas, generated and stored in above mentioned manner, for replacing gas in the subsystem by an inactive gas and for replenishing the subsystem with in order to prevent the absorption caused by the low pressure when the fuel cell power generating system is stopped. Having the normal temperature tank 26 enhances the flexibility of operation of the fuel cell power generating system because the fuel cell power generating system can use the GBD-nitrogen gas, even if the deoxidizer 15 in the tank 8 is being deoxidized or the deoxidization by the deoxidizer 15 has not progressed sufficiently.

In addition, after the deoxidization of the deoxidizer 15, a flammable gas component remains in the tank 8. It is possible to reduce the likelihood of mixing the flammable gas and the oxygen-bearing gas by flowing the GBD-nitrogen gas stored in the normal temperature tank 26 to the tank 8 by opening the cutoff valve 27 and the cutoff valve 21 before supplying the oxygen-bearing gas to the inside of the tank 8.

Obviously, numerous modifications and variations of the present invention are possible in light of the above teachings. For example, it is possible to mix and combine features from the exemplary embodiments above. It is therefore to be understood that within the scope of the appended claims, the invention may be practiced otherwise than as specifically described herein.

This present application contains subject matter related to Japanese patent application no. 2005-114758, filed in the Japanese Patent Office on Apr. 12, 2005, the entire contents of which are incorporated herein by reference.

What is claimed is:

1. A fuel cell power generating system comprising:
a hydrogen supply system configured to supply fuel gas containing hydrogen;
a fuel cell configured to generate electric power from the hydrogen supplied by the hydrogen supply system;
a first tank containing a deoxidizer configured to remove oxygen from an oxygen-bearing gas stored in the first tank;
a booster configured to supply oxygen-bearing gas to the first tank above atmospheric pressure;
an inactive gas line configured to direct inactive gas from the first tank to at least one of the hydrogen supply system and the fuel cell; and
a first cutoff valve located on the inactive gas line.

2. A fuel cell power generating system of claim 1 further comprising:
a deoxidizing gas line configured to direct hydrogen-bearing gas generated within the fuel cell power generating system to the first tank.

3. A fuel cell power generating system of claim 1, wherein the first tank is located within the fuel cell power generating system such that heat generated in the fuel cell power generating system causes the first tank to meet a prescribed temperature condition during operation of the fuel cell power generating system.

4. A fuel cell power generating system of claim 1 further comprising:
a pressure gauge configured to measure the pressure of gas in the first tank; and
an operation circuit configured to determine, based on a rate of decreasing pressure measured by the pressure gauge, whether the deoxidizer in the first tank needs to be changed.

5. A fuel cell power generating system of claim 1 further comprising:
a drain tank configured to collect condensed water from exit gas flowing from the first tank.

6. A fuel cell power generating system of claim 1, further comprising:
a deoxidizing gas line configured to direct deoxidizing gas for deoxidizing the deoxidizer in the first tank to the first tank; and
a deoxidization cutoff valve on the deoxidizing gas line configured to permit the deoxidizing gas to be supplied intermittently to the first tank.

7. A fuel cell power generating system of claim 1 further comprising:
a second tank located between the first tank and the first cutoff valve on the inactive gas line and arranged within the fuel cell power generating system to stay at a temperature lower than that of the first tank; and
a second cutoff valve located between the second tank and the first tank on the inactive gas line, such that the second tank receives the gas deoxidized by the first tank when the second cutoff valve is open.

8. A fuel cell power generating system of claim 7, wherein the second tank and the second cutoff valve are configured to permit gas in the first tank to be replaced by gas stored in the second tank after the deoxidizer in the first tank is deoxidized.

9. A fuel cell power generating system of claim 1 wherein,
the booster is configured to supply the first tank, at least in part, with gas generated by the fuel cell power generating system, the gas having an oxygen concentration lower than that of air.

10. A fuel cell power generating system of claim 1, wherein:
the hydrogen supply system comprises a fuel reforming unit configured to generate the fuel gas; and
the inactive gas line is configured to direct inactive gas from the first tank to at least one of the fuel reforming unit and the fuel cell.

11. A fuel cell power generating system of claim 10 further comprising:
a deoxidizing gas line configured to direct hydrogen-bearing gas generated within the fuel cell power generating system to the first tank.

12. A fuel cell power generating system of claim 10, wherein the first tank is located within the fuel cell power generating system such that heat generated in the fuel cell power generating system causes the first tank to meet a prescribed temperature condition during operation of the fuel cell power generating system.

13. A fuel cell power generating system of claim 10 further comprising:
a pressure gauge configured to measure the pressure of gas in the first tank; and
an operation circuit configured to determine, based on a rate of decreasing pressure measured by the pressure gauge, whether the deoxidizer in the first tank needs to be changed.

14. A fuel cell power generating system of claim 10 further comprising:
a drain tank configured to collect condensed water from exit gas flowing from the first tank.

15. A fuel cell power generating system of claim 10, further comprising:
a deoxidizing gas line configured to direct deoxidizing gas to the first tank; and
a deoxidization cutoff valve on the deoxidizing gas line configured to permit deoxidizing gas for deoxidizing the deoxidizer in the first tank to be supplied intermittently to the first tank.

16. A fuel cell power generating system of claim 10 further comprising:
a second tank located between the first tank and the first cutoff valve on the inactive gas line and arranged within the fuel cell power generating system to stay at a temperature lower than that of the first tank; and
a second cutoff valve located between the second tank and the first tank on the inactive gas line, such that the second tank receives the gas deoxidized by the first tank when the second cutoff valve is open.

17. A fuel cell power generating system of claim 16, wherein the second tank and the second cutoff valve are configured to permit gas in the first tank to be replaced by gas stored in the second tank after the deoxidizer in the first tank is deoxidized.

18. A fuel cell power generating system of claim 10 wherein,
the booster is configured to supply the first tank, at least in part, with gas generated by the fuel cell power generating system, the gas having an oxygen concentration lower than that of air.

19. A fuel cell power generating system comprising:
a tank containing a deoxidizer for generating inactive gas used in the fuel cell power generating system; and
a booster configured to fill the tank with compressed gas to be deoxidized by the deoxidizer in the tank.

20. A fuel cell power generating system of claim 19, further comprising:
a deoxidizing gas supply line configured to supply deoxidizing gas to the tank to deoxidize the deoxidizer in the tank.

21. A fuel cell power generating system comprising:
(a) means storing compressed gas and for generating inactive gas used in the fuel cell power generating system; and
(b) means for supplying the compressed gas to (a) the means for storing and generating.

22. A fuel cell power generating system of claim 21, further comprising:
(c) means for supplying deoxidizing gas to (a) the means for storing and generating.
